(19) United States
(12) Patent Application Publication
(10) Pub. No.: US 2025/0038256 A1
(43) Pub. Date: Jan. 30, 2025

(54) NITRILE ADDITIVES FOR ELECTROLYTES OF BATTERIES INCLUDING LITHIUM- AND MANGANESE-RICH POSITIVE ELECTRODES

(71) Applicant: GM GLOBAL TECHNOLOGY OPERATIONS LLC, Detroit, MI (US)

(72) Inventors: Devendrasinh DARBAR, Sterling Heights, MI (US); Gongshin QI, Troy, MI (US); Chuanlong WANG, Troy, MI (US); Wei LI, Troy, MI (US)

(21) Appl. No.: 18/352,106

(22) Filed: Jul. 13, 2023

(51) Int. Cl. H01M 10/0567; H01M 10/052; H01M 10/0569; H01M 10/42

(52) U.S. Cl. CPC H01M 10/0567; H01M 10/052; H01M 10/0569; H01M 10/4235; H01M 2300/0037

(57) ABSTRACT

A battery that cycles lithium ions includes a positive electrode and an electrolyte infiltrating the positive electrode. The positive electrode includes an electroactive material comprising a lithium-and manganese-rich oxide. The electrolyte includes an organic solvent, an inorganic lithium salt, and a nitrile additive.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to additives for electrolytes of batteries that include layered lithium- and manganese-rich oxides as positive electrode materials to facilitate formation of protective interphase layers on surfaces of the positive electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, in accordance with one or more aspects of the present disclosure, comprises a positive electrode and an electrolyte infiltrating the positive electrode. The positive electrode comprises an electroactive material comprising a lithium-and manganese-rich oxide. The electrolyte comprises an organic solvent, an inorganic lithium salt in the organic solvent, and a nitrile additive in the organic solvent.

The nitrile additive may comprise a mononitrile compound having the formula R—C≡N, where R is an alkyl group, alkenyl group, aryl group, alkoxy group, aryloxy group, carboxyl group, acyloxyl group, or a combination thereof.

In aspects, the nitrile additive may comprise acrylonitrile, propionitrile, 4-methoxybenzonitrile, ethyl 2-cyanoacetate, methyl 2-cyanoacetate, 2-cyanoacetic acid, 2-butenenitrile, benzonitrile, butyl 2-cyanoacetate, tert-butyl 2-cyanoacetate, ethyl cis-(β-cyano)acrylate, α-phenylcinnamonitrile, or a combination thereof.

The nitrile additive may comprise a dinitrile compound having the formula N≡C—R¹—C≡N, where R¹ is a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

In aspects, the nitrile additive may comprise adiponitrile, glutaronitrile, succinonitrile, heptanedinitrile, 2-benzylmalononitrile, Tyrphostin 1, benzylidenemalononitrile, 2-(4-nitrobenzylidene)malononitrile, fumaronitrile, or a combination thereof.

The nitrile additive may comprise a trinitrile compound having the formula:

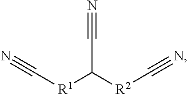

where R¹ and R² are each individually a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

In aspects, the nitrile additive may comprise hexane-1,3,6-tricarbonitrile.

The nitrile additive may comprise a tetranitrile compound having the formula:

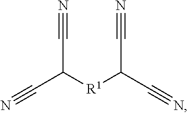

where R¹ is a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

In aspects, the nitrile additive may comprise tetracyanoethylene; 7,7,8,8-tetracyanoquinodimethane; 2,3,5,6-Tetrafluoro-7,7,8,8-tetracyanoquinodimethane; or a combination thereof.

The nitrile additive may constitute, by weight, greater than or equal to about 0.001% to less than or equal to about 10% of the electrolyte.

The electrolyte may further comprise, by weight, greater than or equal to about 0.001% to less than or equal to about 3% fluoroethylene carbonate (FEC).

During cycling of the battery, the nitrile additive may decompose and forms an interphase layer on surfaces of the electroactive material of the positive electrode that isolates the electroactive material from physical contact with the electrolyte.

The battery may further comprise an interphase layer formed in situ on the electroactive material of the positive electrode during cycling of the battery. The interphase layer may comprise an imino-functional organic compound, a cyano-functional organic compound, or a combination thereof. The interphase layer may physically isolate the electroactive material of the positive electrode from contact with the electrolyte.

The inorganic lithium salt may comprise lithium hexafluorophosphate (LiPF₆).

A battery that cycles lithium ions, in accordance with one or more aspects of the present disclosure, comprises a positive electrode, a negative electrode, and an electrolyte infiltrating the positive electrode and the negative electrode. The positive electrode comprises an electroactive material comprising a lithium-and manganese-rich oxide. The negative electrode comprises an electroactive material comprising silicon oxide and graphite. The electrolyte comprises an organic solvent, an inorganic lithium salt in the organic solvent, and a nitrile additive in the organic solvent. The organic solvent comprises a cyclic carbonate and a linear carbonate. The inorganic lithium salt comprises lithium hexafluorophosphate (LiPF₆).

The nitrile additive may comprise acrylonitrile, propionitrile, 4-methoxybenzonitrile, ethyl 2-cyanoacetate, methyl 2-cyanoacetate, 2-cyanoacetic acid, 2-butenenitrile, benzonitrile, butyl 2-cyanoacetate, tert-butyl 2-cyanoacetate, ethyl cis-(β-cyano)acrylate, α-phenylcinnamonitrile, adiponitrile, glutaronitrile, succinonitrile, heptanedinitrile, 2-benzylmalononitrile, Tyrphostin 1, benzylidenemalononitrile, 2-(4-nitrobenzylidene)malononitrile, fumaronitrile, hexane-1,3,6-tricarbonitrile, tetracyanoethylene; 7,7,8,8-tetracyanoquinodimethane; 2,3,5,6-Tetrafluoro-7,7,8,8-tetracyanoquinodimethane; or a combination thereof.

The battery may further comprise a first interphase layer disposed on the electroactive material of the positive electrode and a second interphase layer disposed on the electroactive material of the negative electrode. The first interphase layer may physically isolate the electroactive material of the positive electrode from contact with the electrolyte. The second interphase layer may physically isolate the electroactive material of the negative electrode from contact with the electrolyte. The first interphase layer and the second interphase layer may be formed in situ during cycling of the battery. The first interphase layer and the second interphase layer may comprise decomposition products of the nitrile additive.

In aspects, electrochemical oxidation of the nitrile additive may occur at the positive electrode during charge of the battery. In such case, the first interphase layer may comprise an imino-functional organic compound, a cyano-functional organic compound, or a combination thereof.

The first interphase layer may further comprise lithium fluoride (LiF).

Electrochemical reduction of the nitrile additive may occur at the negative electrode during charge of the battery. In such case, the second interphase layer may comprise byproducts of the electrochemical reduction of the nitrile additive.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating pores of the positive and negative electrodes and the porous separator.

FIG. 4 is a plot of Discharge Capacity Retention (%) versus Cycle Number for full coin cells including a control electrolyte (dotted line), 0.5 wt % UT electrolyte (dashed line), 1 wt % UT electrolyte (dash-dot-dash line), and 2 wt % UT electrolyte (solid line).

In the drawings, reference numbers may be reused to identify similar and/or identical elements.

### DETAILED DESCRIPTION

The presently disclosed electrolytes are formulated for use in batteries that cycle lithium ions and include layered lithium- and manganese-rich oxides (LMRs) as positive electrode materials, which may operate at ultra-high voltages (e.g., >4.5 V versus Li⁺/Li). The presently disclosed electrolytes comprise a nitrile additive that is formulated to decompose during cycling of the batteries to form protective interphase layers surfaces of the positive and negative electrode materials. The protective interphase layers formed by the nitrile additive help isolate the positive and negative electrode materials from physical contact with the electrolyte, which may help improve the cycling stability and capacity retention of the battery, for example, by preventing undesirable chemical reactions from occurring between the positive and negative electrode materials and the electrolyte during cycling of the battery.

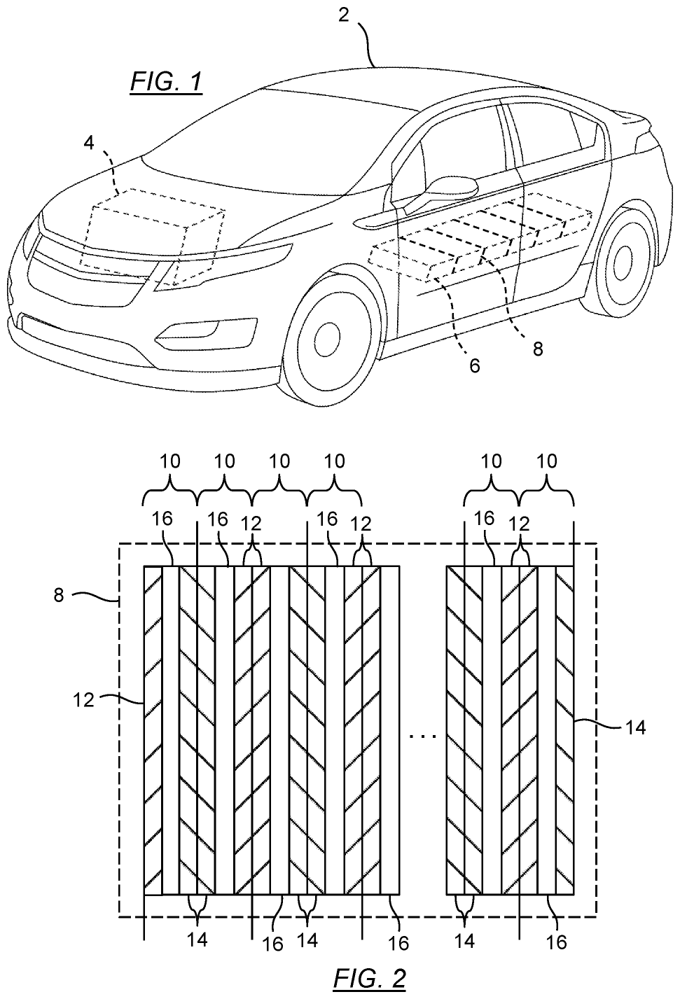

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

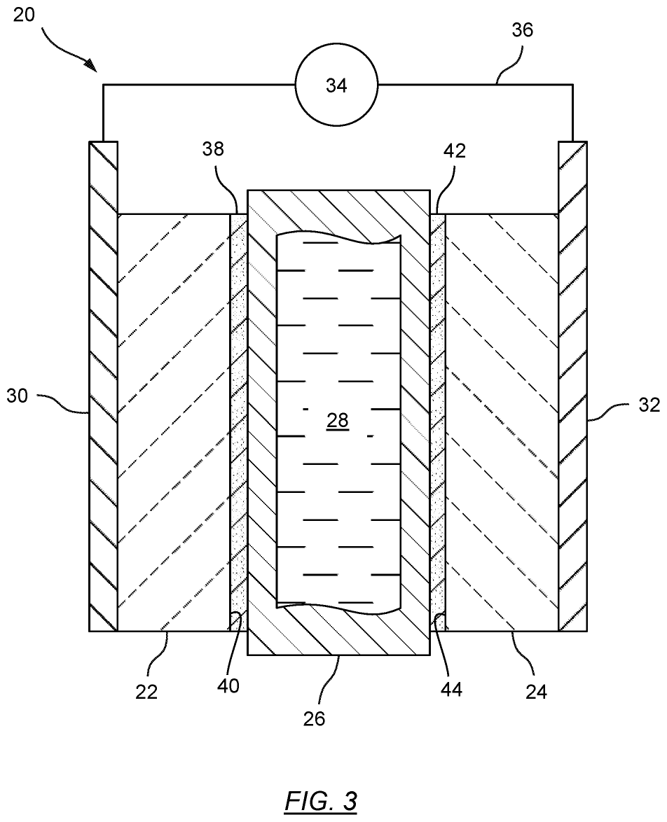

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that wets surfaces of the negative electrode 22, the positive electrode 24, and the separator 26. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous redox reactions within the battery 20 and the release of lithium ions and electrons at the negative electrode 22. The released lithium ions travel from the negative electrode 22 to the positive electrode 24 through the separator 26 and the electrolyte 28, and the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is configured to store and release lithium ions during charge and discharge of the battery 20. The negative electrode 22 may be in the form of a continuous layer of material disposed on a major surface of the negative electrode current collector 30. The negative electrode 22 is configured to store and release lithium ions to facilitate charge and discharge, respectively, of the battery 20. To accomplish this, the negative electrode 22 includes one or more electrochemically active (electroactive) materials that can facilitate the storage and release of lithium ions by undergoing a reversible redox reaction with lithium during charge and discharge of the battery 20. Examples of electroactive materials for the negative electrode 22 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof.

In some aspects, the negative electrode 22 may be in the form of a nonporous metal film or foil, such as a lithium metal film or lithium metal foil. In other aspects, the negative electrode 22 may be porous and the electroactive material of the negative electrode 22 may be a particulate material. In such case, particles of the electroactive material of the negative electrode 22 may be intermingled with a polymer binder and/or an electrically conductive material. The polymer binder may provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The electrically conductive material may provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. In aspects, the negative electrode 22 may comprise an electrically conductive material comprising carbon black.

The positive electrode 24 is configured to store and release lithium ions during discharge and charge of the battery 20. The positive electrode 24 may be in the form of a continuous porous layer disposed on the major surface of the positive electrode current collector 20. The positive electrode 24 comprises one or more electrochemically active (electroactive) materials that can undergo a reversible redox reaction with lithium at a higher electrochemical potential than the electroactive material of the negative electrode 22 such that an electrochemical potential difference exists between the positive and negative electrodes 12, 14. For example, the electroactive material of the positive electrode 24 may comprise an intercalation host material that can undergo the reversible insertion or intercalation of lithium ions. In such case, the electroactive material of the positive electrode 24 may comprise a layered oxide represented by the formula LiMeO₂ and/or Li₂MeO₃, a layered lithium-rich oxide represented by the formula Li₁₊ₓMe₁₋ₓO₂ (where 0<x≤0.33), an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to about 80%, optionally about 90%, optionally about 95% to less than or equal to about 99%, or optionally about 98% of the positive electrode 24.

In aspects, the electroactive material of the positive electrode 24 may comprise a layered lithium-rich manganese-based transition metal oxide represented by the formula Li₁₊ₓMe₁₋ₓO₂ (where 0<x≤0.33), where Me comprises, by weight, greater than or equal to about 50% manganese (Mn). In some aspects, the electroactive material of the positive electrode 24 may comprise a layered lithium- and manganese-rich oxide represented by the formula Li₂MnO₃ (LMR). In aspects, the electroactive material of the positive electrode 24 may comprise a layered lithium-rich nickel-based transition metal oxide represented by the formula Li₁₊ₓMe₁₋ₓO₂ (where 0<x≤0.33), where Me comprises, by weight, greater than or equal to about 50% nickel (Ni). In aspects, the electroactive material of the positive electrode 24 may comprise lithium manganese iron phosphate (LMFP), lithium iron phosphate (LFP), spinel lithium manganese oxide (LiMn₂O₄, LMO), high voltage spinel (LiNi_{0.5}Mn_{1.5}O₄, LNMO), lithium nickel cobalt manganese aluminum oxide (NCMA), lithium nickel manganese cobalt oxide (NMC), lithium nickel manganese oxide (LNMO), e.g., LiNi_{0.5}Mn_{1.5}O₄ and/or Li_{1.2}Ni_{0.2}Mn_{0.6}O₂, lithium nickel cobalt aluminum oxide (NCA), or a combination thereof.

Like the electroactive material of the negative electrode 22, the electroactive material of the positive electrode 24 may be a particulate material and particles of the electroactive material of the positive electrode 24 may be intermingled with a polymer binder and/or particles of an electrically conductive material. The same polymer binders and/or electrically conductive materials disclosed above with respect to the negative electrode 22 may be used in the positive electrode 24. In aspects, the positive electrode 24 may comprise a polymer binder comprising polyvinylidene fluoride.

The separator 26 physically separates and electrically isolates the negative and positive electrodes 22, 24 from each other while permitting lithium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVdF), and/or poly(vinyl chloride) (PVC). In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive provides a medium for the conduction of lithium ions between the negative and positive electrodes 22, 24 and is formulated to provide the battery 20 with enhanced cycling stability. The electrolyte 28 comprises an organic solvent, an inorganic lithium salt, a nitrile additive, and optionally a co-additive. As shown in FIG. 3, the nitrile additive and the optional co-additive are formulated to assist in formation of a first interphase layer 38 on surfaces 40 of the negative electrode 22 and a second interphase layer 42 on surfaces 44 of the positive electrode 24.

The organic solvent may comprise a nonaqueous aprotic organic solvent or a mixture of nonaqueous aprotic organic solvents. Non-limiting examples of nonaqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), and combinations thereof. The organic solvent may constitute, by weight, greater than or equal to about 70% to less than or equal to about 90% of the electrolyte 28. In aspects, the organic solvent may comprise a mixture of a cyclic carbonate and a linear carbonate. For example, the organic solvent may comprise a mixture of FEC and DEC. In such case, the volumetric ratio of FEC to DEC in the organic solvent may be about 1:4.

The inorganic lithium salt is soluble in the organic solvent and provides a passage for lithium ions through the electrolyte 28. Examples of inorganic lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. The lithium salt may be dissolved in the organic solvent at a concentration of greater than or equal to about 0.5 Molar to less than or equal to about 1.5 Molar. In aspects, the lithium salt may be dissolved in the organic solvent at a concentration of about 1 Molar. The lithium salt may constitute, by weight, greater than or equal to about 5% to less than or equal to about 20% of the electrolyte 28. In aspects, the lithium salt comprises LiPF₆.

The nitrile additive is formulated to assist in formation of the first interphase layer 38 and the second interphase layer 42 during initial charge and/or cycling of the battery 20.

The nitrile additive is a chemical compound comprising a nitrile group (—C≡N). For example, the nitrile additive may be a mononitrile compound comprising a single nitrile group and having the following formula (1):

R−C≡N. (1)

where R is an organic group. For example, R may be a C₁-C₁₀ straight-chain or branched chain acyclic or cyclic univalent hydrocarbon group. For example, R may be a C₁-C₁₀ straight-chain or branched chain alkyl group (—CₙH₂ₙ₊₁), alkenyl group (—CₙH₂ₙ₋₁, where n is ≥2), aryl group, alkoxy group, aryloxy group, carboxyl group, acyloxyl group, or a combination thereof.

Examples of straight-chain C₁-C₁₀ alkyl groups include methyl groups (—CH₃), ethyl groups (—CH₂CH₃), propyl groups (—CH₂CH₂CH₃), and butyl groups (—CH₂CH₂CH₂CH₃). Examples of branched-chain C₁-C₁₀ alkyl groups include isopropyl groups (—CH(CH₃)₂), isobutyl groups (—CH₂—CH(CH₃)₂), sec-butyl groups (—(CH₃)CH—CH₂—CH₃), tert-butyl groups (—C(CH₃)₃), isopentyl groups (—(CH₂)₂—CH(CH₃)₂), and tert-pentyl groups (—(CH₃)₂C—CH₂—CH₃). Alkenyl groups are aliphatic hydrocarbon groups with at least one carbon-carbon double bond (C═C) and are formed when a hydrogen atom is removed from an alkene group. Example alkenyl groups include vinyl groups (—CH═CH₂), allyl groups (—CH₂—HC═CH₂), propenyl groups (—CH═CHCH₃), isopropenyl (—(CH₃)C═CH₂), ethylidene groups (═CH—CH₃), isopropylidene groups (═C(CH₃)₂). Examples of aryl groups include phenyl groups (—C₆H₅), benzyl groups (—CH₂—C₆H₅), benzylidene groups (═CH—C₆H₅), styryl groups (—CH═CH—C₆H₅), phenethyl groups (—CH₂—CH₂—C₆H₅), cinnamyl groups (—CH₂—CH═CH—C₆H₅), benzhydryl groups (—CH(C₆H₅)₂), An alkoxy group is an alkyl group singularly bonded to oxygen (—O—X, where X is an alkyl group). An aryloxy group is an aryl group singularly bonded to oxygen (—O—Y, where Y is an aryl group). Examples of alkoxy groups include methoxy groups (—OCH₃) and ethoxy groups (—OCH₂CH₃). Examples of aryloxy groups include phenoxy groups (—OC₆H₅). Carboxyl groups are organic functional groups consisting of a carbon atom doubled bonded to an oxygen atom and single bonded to a hydroxyl group (—C(═O)OH). Acyloxyl groups are represented by the formula —O—(C═O)—X, where X is an alkyl group. In aspects, R may be a methoxybenzyl group, methoxybenzylidene group, or nitrobenzylidene group.

Examples of mononitrile compounds of formula (1) include acrylonitrile (CAS No. 107-13-1), propionitrile (CAS No. 107-12-0), 4-methoxybenzonitrile (CAS No. 874-90-8), ethyl 2-cyanoacetate (CAS No. 105-56-6), methyl 2-cyanoacetate (CAS No. 105-34-0), 2-cyanoacetic acid (CAS No. 372-09-8), 2-butenenitrile (CAS No. 4786-20-3), benzonitrile (CAS No. 100-47-0), butyl 2-cyanoacetate (CAS No. 5459-58-5), tert-butyl 2-cyanoacetate (CAS No. 1116-98-9), ethyl cis-(β-cyano)acrylate (CAS No. 40594-97-6), and α-phenylcinnamonitrile (CAS No. 2510-95-4).

As another example, the nitrile additive may be a dinitrile compound comprising two nitrile groups and having the following formula (2):

N≡C−R¹−C≡N (2)

where R¹ is an organic group. For example, R¹ may be a C₁-C₁₀ straight-chain or branched chain acyclic or monocyclic bivalent hydrocarbon group. For example, R¹ may be a methylene group (—CH₂—), ethylene group (—CH₂—CH₂—), trimethylene group (—CH₂—CH₂—CH₂—), tetramethylene group, pentamethylene group, hexamethylene group, vinylene group (—HC═CH—), propenylene group (—H₂C═C═CH—), propylene group (—CH(CH₃)CH₂—), phenylene group (—C₆H₄—), tetrafluorophenylene group, or a cyclohexadiene group.

Examples of dinitrile compounds of formula (2) include adiponitrile (CAS No. 111-69-3), glutaronitrile (CAS No. 544-13-8), succinonitrile (CAS No. 110-61-2), heptanedinitrile (CAS No. 646-20-8), 2-benzylmalononitrile (CAS No. 1867-37-4), Tyrphostin 1 or (4-methoxybenzylidene)malononitrile (CAS No. 2826-26-8), benzylidenemalononitrile (CAS No. 2700-22-3, MP=85° C., BP=120° C.), 2-(4-nitrobenzylidene)malononitrile (CAS No. 2700-23-4), and fumaronitrile (CAS No. 764-42-1).

As another example, the nitrile additive may be a trinitrile compound having the following formula (3):

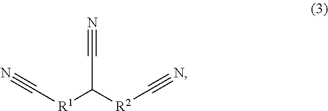

where R¹ and R² are organic groups. The R¹ and R² groups may be C₁-C₁₀ straight-chain or branched chain acyclic or monocyclic bivalent hydrocarbon groups. For example, R¹ and R² each individually may be a methylene group (—CH₂—), ethylene group (—CH₂—CH₂—), a trimethylene group (—CH₂—CH₂—CH₂—), tetramethylene, pentamethylene, hexamethylene, vinylene (—HC═CH—), propenylene (—H₂C═C═CH—), propylene (—CH(CH₃)CH₂—), phenylene group (—C₆H₄-), tetrafluorophenylene group, or a cyclohexadiene group.

An example of a trinitrile compound of formula (3) is hexane-1,3,6-tricarbonitrile (CAS No. 1772-25-4).

As another example, the nitrile additive may be a tetranitrile compound having the following formula (4):

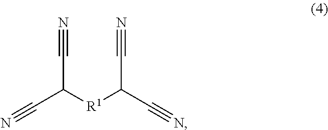

where R¹ is an organic group. For example, R¹ may be a C₁-C₁₀ straight-chain or branched chain acyclic or monocyclic bivalent hydrocarbon group. For example, R¹ may be a methylene group (—CH₂—), ethylene group (—CH₂—CH₂—), a trimethylene group (—CH₂—CH₂—CH₂—), tetramethylene, pentamethylene, hexamethylene, vinylene (—HC═CH—), propenylene (—H₂C═C═CH—), propylene (—CH(CH₃)CH₂—), phenylene group (—C₆H₄—), tetrafluorophenylene group, or a cyclohexadiene group.

Examples of tetranitrile compounds of formula (4) include tetracyanoethylene or ethylenetetracarbonitrile (CAS No. 670-54-2); 7,7,8,8-tetracyanoquinodimethane (CAS No. 1518-16-7); and 2,3,5,6-Tetrafluoro-7,7,8,8-tetracyanoquinodimethane (CAS No. 29261-33-4).

The nitrile additive may constitute, by weight, greater than or equal to about 0.001%, optionally about 0.01%, optionally about 0.1% to less than or equal to about 10%, optionally about 3%, or optionally about 1% of the electrolyte 28. In aspects, the nitrile additive may constitute, by weight, about 0.5% of the electrolyte 28.

The optional co-additive is formulated to assist in the formation of the first interphase layer 38 and/or the second interphase layer 42. The optional co-additive may comprise fluoroethylene carbonate (FEC). The optional co-additive may constitute, by weight, greater than or equal to about 0.001%, optionally about 0.01%, optionally about 0.1% to less than or equal to about 3%, or optionally about 1% of the electrolyte 28.

The first interphase layer 38 and the second interphase layer 42 may inherently form in situ respectively on surfaces 40 of the negative electrode 22 and surfaces 44 of the positive electrode 24 during initial charge and/or cycling of the battery 20, for example, due to chemical reactions between the nitrile additive and the optional co-additive in the electrolyte 28 and the electroactive materials of the negative and positive electrodes 22, 24. The first interphase layer 38 may inherently form in situ on surfaces of the negative electrode 22 during initial charge and/or cycling of the battery 20 due to the electrochemical reduction of the nitrile additive and/or the optional co-additive in the electrolyte 28 on surfaces 40 of the electroactive material of the negative electrode 22. The first interphase layer 38 may comprise the electrochemical decomposition products of the nitrile additive and/or the optional co-additive. Specifically, the first interphase layer 38 may comprise the reaction products of the electrochemical reduction of the nitrile additive and/or the optional co-additive.

The second interphase layer 42 may inherently form in situ on surfaces 44 of the positive electrode 24 during initial charge and/or cycling of the battery 20 due to the electrochemical oxidation of the nitrile additive in the electrolyte 28 on surfaces 44 of the electroactive materials of the positive electrode 24. Without intending to be bound by theory, it is believed that the nitrile additive may be preferentially oxidized on surfaces 44 of the positive electrode 24 during initial charge and/or cycling of the battery 20, instead of the other components of the electrolyte 28. In other words, it is believed that the nitrile additive may act as a sacrificial component of the electrolyte 28, thereby preventing degradation of the electrolyte 28 during charge and cycling of the battery 20. In turn, the preferential oxidation of the nitrile additive, instead of the other components of the electrolyte 28, may allow the battery 20 to effectively and efficiently operate at a relatively high potential, as compared to electrochemical cells that do not include the nitrile additive. In aspects where the lithium salt comprises LiPF₆, the nitrile additive may be preferentially oxidized along with PF₆⁻ anions on surfaces 44 of the positive electrode 24 during initial charge and/or cycling of the battery 20, instead of the other components of the electrolyte 28, which may inhibit or prevent the undesirable generation of HF within the battery 20. In addition, oxidation of the nitrile additive on surfaces 44 of the positive electrode 24 may beneficially result in the formation of LiF and/or imino (═NH)-containing chemical compounds (i.e., imines), which may be incorporated into the structure of the second interphase layer 42 and help form a robust protective interphase on surfaces 44 of the positive electrode 24. The second interphase layer 42 may comprise the electrochemical decomposition products of the nitrile additive and optionally the LiPF₆ lithium salt. In particular, the second interphase layer 42 may comprise the reaction products of the electrochemical oxidation of the nitrile additive and optionally the LiPF₆ lithium salt. Examples of such oxidation products include LiF, organic chemical compounds having imino (═NH) functional groups, (i.e., imines, imino-functional organic compounds, or primary imines), and/or organic chemical compounds having cyano (—C—N) functional groups (i.e., nitriles or cyano-functional organic compounds).

The first and second interphase layers 38, 42 are electrically insulating and ionically conductive and are configured to help prevent undesirable chemical reactions from occurring between the electrolyte 28 and the respective negative and positive electrodes 22, 24 during cycling of the battery 20. For example, after the first and second interphase layers 38, 42 are formed respectively on surfaces 40, 44 of the negative and positive electrodes 22, 24, the first and second interphase layers 38, 42 may help prevent chemical reactions from occurring between the components of the electrolyte 28 and the negative and positive electrodes 22, 24 during charge and/or discharge of the battery 20. Without intending to be bound by theory, it is believed that formation of the first and second interphase layers 38, 42 may help prevent undesirable chemical reactions from occurring between the electrolyte 28 and the respective negative and positive electrodes 22, 24, without impeding the flow of lithium ions between the electrolyte 28 and the negative and positive electrodes 22, 24.

In FIG. 3, the first interphase layer 38 is depicted as being disposed along an interface between the negative electrode 22 and the separator 26 and the second interphase layer 42 is depicted as being disposed along an interface between the positive electrode 24 and the separator 26; however other arrangements are possible. For example, in aspects where the electroactive material of the negative and positive electrodes 22, 24 are in the form of particulate materials, the first interphase layer 38 may extend at least partway into the negative electrode 22 (toward the negative electrode current collector 30) and may be disposed on surfaces of one or more of the electroactive material particles of the negative electrode 22. Likewise, in aspects, the second interphase layer 42 may extend at least partway into the positive electrode 24 (toward the positive electrode current collector 32) and may be disposed on surfaces of one or more of the electroactive material particles of the positive electrode 24.

The positive and negative electrode current collectors 30, 32 are electrically conductive and provide an electrical connection between the external circuit 36 and their respective positive and negative electrodes 22, 24. In aspects, the positive and negative electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

### EXPERIMENTAL

Full coin cells including different electrolyte formulations were assembled and evaluated using galvanostatic charge and discharge protocols. All cells included a negative electrode consisting of: an electroactive material consisting of a mixture of graphite and silicon oxide, electrically conductive particles, and a polymer binder. All cells included a positive electrode consisting of: an electroactive material consisting of Li₂MnO₃, electrically conductive particles, and a polymer binder. A control electrolyte was prepared consisting of: 1.2 Molar LiPF₆ in a mixture of FEC and DEC (FEC:DEC=1:4 vol/vol). Electrolytes in accordance with embodiments of the present disclosure were prepared by adding to the control electrolyte various amounts of hexane-1,3,6-tricarbonitrile (UT), i.e., 0.5 wt % UT, 1 wt % UT, or 2 wt % UT.

Cells including the control electrolyte, 0.5 wt % UT electrolyte, 1 wt % UT electrolyte, and 2 wt % UT electrolyte were galvanostatically charged and discharged at 25° C. During formation, the cells were charged at a C/20 rate to 4.5 V. Then, a constant current and constant voltage (CCCV) protocol was used to charge the cells at a constant current using a C/20 charge rate to a potential of about 4.5 V, then constant voltage charge at 4.5 V until the current reached C/50. The cells were subsequently discharged at a constant current using a C/20 discharge rate to 2.0 V.

During formation, the cells were charged at a C/20 rate to 4.5V for 2 cycles using CCCV protocol. A constant current and constant voltage (CCCV) protocol was used to charge the cells at a constant current using a C/20 charge rate to a potential of about 4.5 V, then constant voltage charge at 4.5V until the current reached C/50. The cells were subsequently discharged at a constant current using a C/20 discharge rate to 2.0 V. In the following cycles, the cells were cycled between 2.0 V and 4.4 V. using a CCCV protocol. A CCCV protocol was used to charge the cells at a constant current using a C/3 charge rate to a potential of about 4.4 V, then constant voltage charge at 4.4 V until the current reached C/20. The cells were subsequently discharged at a constant current using a C/3 discharge rate to 2.0 V.

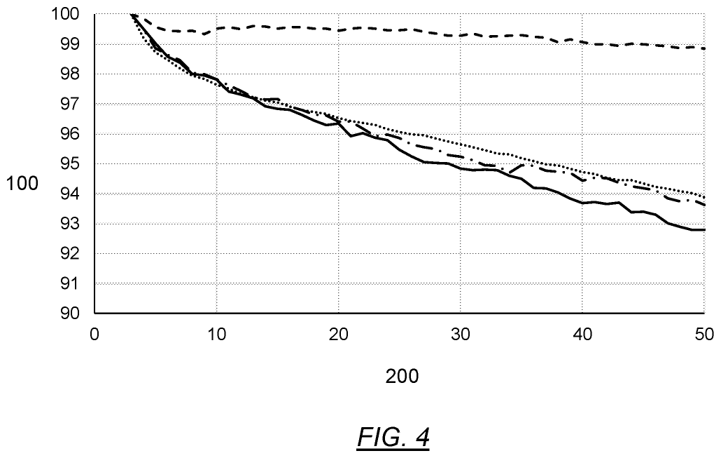

FIG. 4 is a plot of Discharge Capacity Retention (%) 100 versus Cycle Number 200 for cells including the control electrolyte (dotted line), 0.5 wt % UT electrolyte (dashed line), 1 wt % UT electrolyte (dash-dot-dash line), and 2 wt % UT electrolyte (solid line). As shown in FIG. 4, cells including LiF-containing electrolytes exhibited higher capacity retention than cells including the control electrolyte.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a positive electrode comprising an electroactive material comprising a lithium-and manganese-rich oxide; and
an electrolyte infiltrating the positive electrode, the electrolyte comprising:
an organic solvent;
an inorganic lithium salt in the organic solvent; and
a nitrile additive in the organic solvent.

2. The battery of claim 1, wherein the nitrile additive comprises a mononitrile compound having the formula R—C≡N, where R is an alkyl group, alkenyl group, aryl group, alkoxy group, aryloxy group, carboxyl group, acyloxyl group, or a combination thereof.

3. The battery of claim 2, wherein the nitrile additive comprises acrylonitrile, propionitrile, 4-methoxybenzonitrile, ethyl 2-cyanoacetate, methyl 2-cyanoacetate, 2-cyanoacetic acid, 2-butenenitrile, benzonitrile, butyl 2-cyanoacetate, tert-butyl 2-cyanoacetate, ethyl cis-(β-cyano)acrylate, α-phenylcinnamonitrile, or a combination thereof.

4. The battery of claim 1, wherein the nitrile additive comprises a dinitrile compound having the formula N≡C—R¹—C≡N, where R¹ is a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

5. The battery of claim 4, wherein the nitrile additive comprises adiponitrile, glutaronitrile, succinonitrile, heptanedinitrile, 2-benzylmalononitrile, Tyrphostin 1, benzylidenemalononitrile, 2-(4-nitrobenzylidene)malononitrile, fumaronitrile, or a combination thereof.

6. The battery of claim 1, wherein the nitrile additive comprises a trinitrile compound having the formula: 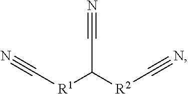
where R¹ and R² are each individually a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

7. The battery of claim 6, wherein the nitrile additive comprises hexane-1,3,6-tricarbonitrile.

8. The battery of claim 1, wherein the nitrile additive comprises a tetranitrile compound having the formula: 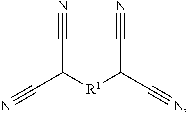
where R¹ is a methylene group, ethylene group, trimethylene group, tetramethylene group, pentamethylene group, hexamethylene group, vinylene group, propenylene group, propylene group, phenylene group, tetrafluorophenylene group, or cyclohexadiene group.

9. The battery of claim 8, wherein the nitrile additive comprises tetracyanoethylene; 7,7,8,8-tetracyanoquinodimethane; 2,3,5,6-Tetrafluoro-7,7,8,8-tetracyanoquinodimethane; or a combination thereof.

10. The battery of claim 1, wherein the nitrile additive constitutes, by weight, greater than or equal to about 0.001% to less than or equal to about 10% of the electrolyte.

11. The battery of claim 1, wherein the electrolyte further comprises, by weight, greater than or equal to about 0.001% to less than or equal to about 3% fluoroethylene carbonate (FEC).

12. The battery of claim 1, wherein, during cycling of the battery, the nitrile additive decomposes and forms an interphase layer on surfaces of the electroactive material of the positive electrode that isolates the electroactive material from physical contact with the electrolyte.

13. The battery of claim 1, further comprising:
an interphase layer formed in situ on the electroactive material of the positive electrode during cycling of the battery,
wherein the interphase layer comprises an imino-functional organic compound, a cyano-functional organic compound, or a combination thereof,
wherein the interphase layer physically isolates the electroactive material of the positive electrode from contact with the electrolyte.

14. The battery of claim 1, wherein the inorganic lithium salt comprises lithium hexafluorophosphate (LiPF₆).

15. A battery that cycles lithium ions, the battery comprising:
a positive electrode comprising an electroactive material comprising a lithium-and manganese-rich oxide;
a negative electrode comprising an electroactive material comprising silicon oxide and graphite; and
an electrolyte infiltrating the positive electrode and the negative electrode, the electrolyte comprising:
an organic solvent comprising a cyclic carbonate and a linear carbonate;
an inorganic lithium salt in the organic solvent, the inorganic lithium salt comprising lithium hexafluorophosphate (LiPF₆); and
a nitrile additive in the organic solvent.

16. The battery of claim 15, wherein the nitrile additive comprises acrylonitrile, propionitrile, 4-methoxybenzonitrile, ethyl 2-cyanoacetate, methyl 2-cyanoacetate, 2-cyanoacetic acid, 2-butenenitrile, benzonitrile, butyl 2-cyanoacetate, tert-butyl 2-cyanoacetate, ethyl cis-(β-cyano)acrylate, α-phenylcinnamonitrile, adiponitrile, glutaronitrile, succinonitrile, heptanedinitrile, 2-benzylmalononitrile, Tyrphostin 1, benzylidenemalononitrile, 2-(4-nitrobenzylidene)malononitrile, fumaronitrile, hexane-1,3,6-tricarbonitrile, tetracyanoethylene; 7,7,8,8-tetracyanoquinodimethane; 2,3,5,6-Tetrafluoro-7,7,8,8-tetracyanoquinodimethane; or a combination thereof.

17. The battery of claim 15, further comprising:
a first interphase layer disposed on the electroactive material of the positive electrode that physically isolates the electroactive material of the positive electrode from contact with the electrolyte; and
a second interphase layer disposed on the electroactive material of the negative electrode that physically isolates the electroactive material of the negative electrode from contact with the electrolyte,
wherein the first interphase layer and the second interphase layer are formed in situ during cycling of the battery, and
wherein the first interphase layer and the second interphase layer comprise decomposition products of the nitrile additive.

18. The battery of claim 17, wherein electrochemical oxidation of the nitrile additive occurs at the positive electrode during charge of the battery, and wherein the first interphase layer comprises an imino-functional organic compound, a cyano-functional organic compound, or a combination thereof.

19. The battery of claim 18, wherein the first interphase layer further comprises lithium fluoride (LiF).

20. The battery of claim 17, wherein electrochemical reduction of the nitrile additive occurs at the negative electrode during charge of the battery, and wherein the second interphase layer comprises byproducts of the electrochemical reduction of the nitrile additive.
